(19) United States
(12) Patent Application Publication
(10) Pub. No.: US 2026/0044811 A1
(43) Pub. Date: Feb. 12, 2026

(54) REUSABLE GOODS CARRIER, GOODS CARRIER CIRCULATION SYSTEM, MOBILE LOGISTICS DATA NETWORK AND METHOD FOR TRANSMITTING LOCATION INFORMATION OF REUSABLE GOODS CARRIERS WITHIN A GOODS CARRIER CIRCULATION SYSTEM

(71) Applicant: IFCO Management GmbH, Pullach (DE)

(72) Inventors: Daniel Schlueter, Pullach (DE); Sebastian Grams, Pullach (DE)

(21) Appl. No.: 18/827,926

(22) Filed: Sep. 9, 2024

(30) Foreign Application Priority Data
Aug. 8, 2024 (DE) 10 2024 122 745.1

(51) Int. Cl. G06Q 10/0833; B65D 25/20

(52) U.S. Cl. CPC G06Q 10/0833; B65D 25/20

(57) ABSTRACT

A returnable goods carrier is shown that is designed and adapted for being used in a goods carrier circulation system. An access point for a beacon is attached to the goods carrier. Furthermore, a goods carrier circulation system and a mobile logistics data network are shown, as well as a method for transmitting location information from returnable goods carriers that circulate within the goods carrier circulation system.

The invention relates to a reusable goods carrier that is designed and adapted for being used in a goods carrier circulation system, as well as a goods carrier circulation system with a large number of such reusable goods carriers. Furthermore, the invention relates to a method for transmitting location information from reusable goods carriers within a goods carrier circulation system, and to a mobile logistics data network set up by means of the reusable goods carriers.

### BACKGROUND OF THE INVENTION

It is known that reusable plastic goods carriers are used to transport goods between a producer, a distribution center or an intermediary and a retailer, and that these goods carriers are circulated in a cycle. The reusable goods carriers may be, for example, crates, pallets, trays or box-shaped or container-shaped containers. In particular, reusable goods carriers that are not designed as pallets or trays are often foldable or collapsible goods carriers, in order to transport and store the reusable goods carriers in the most space-saving way possible when they are not in use.

When the returnable goods carriers are crates, they are used in particular for transporting fruit and vegetables. When they are pallets, a wide variety of goods can be stacked on them.

The returnable goods carriers are particularly suitable for use in goods carrier circulation systems, in which the returnable goods carriers are circulated between different stations. The individual stations of the goods carrier circulation system include, for example, loading stations, logistics centers, means of transport and points of sale, but also storage centers and cleaning stations.

Usually, the reusable goods carriers are provided by a service provider who is responsible for inspecting and cleaning the reusable goods carriers after use and often also for returning them to the loading station.

The goods carrier circulation systems often include several hundred thousand reusable goods carriers, depending on how many countries and participants the goods carrier circulation systems includes. Accordingly, it is important for the service provider of the goods carrier circulation system to know the number, type and location of the reusable goods carriers for logistics purposes, especially since the reusable goods carriers not only circulate between the different stations, but also between the individual participants in the goods carrier circulation system, such as producers, distributors and points of sale. If the service provider knows, for example, how many reusable racks are at a loading station, new reusable racks can be delivered there in good time as soon as the stock falls below a predefined threshold.

To locate reusable goods carriers in the goods carrier circulation system, it is known that barcodes can be attached to the reusable goods carriers for scanning. In this process, an identification number of the respective reusable goods carrier can be read from the barcodes, which can be assigned in the service provider's database so that, in addition to the location information for the reusable goods container, information about its current use can also be obtained.

Furthermore, it is known to equip the reusable goods carriers with a transponder that contains an identifier. This information can then be received by a reader, in particular a receiving antenna, and forwarded to the service provider. For example, the transponder can be an RFID label and the receiving antenna is an RFID reader that is permanently installed at predetermined locations. However, since the RFID readers are comparatively expensive, the costs for the goods carrier circulation system and thus also for participants in the goods carrier circulation system are very high.

Alternatively, a Bluetooth Low Energy (BLE) beacon can be used as a transponder, which is significantly cheaper to purchase as an access point. However, to read the identifier stored in it and forward it to the service provider, BLE access points are required, which are usually equipped with GPS and a connection to a telecommunications network. However, to ensure reliable monitoring of the goods carrier circulation system, a large number of these BLE access points must be installed, especially at producers, suppliers and in supermarkets.

To obtain the desired information density, it is necessary to install a large number of access points, for example in supermarkets and at transport service providers. This results in a high level of effort. In addition, the monitoring options for the reusable goods carriers mentioned in the prior art cannot provide real-time information, since the reusable goods carriers must be in the vicinity of an access point connected to the telecommunications network in order to forward the identifier of the reusable goods carrier's beacon to the service provider.

Thus, one object of the invention is to provide a goods carrier circulation system in which information on the circulating reusable goods carriers can be retrieved at any time without increasing the costs incurred for the goods carrier circulation system.

### BRIEF DESCRIPTION OF THE INVENTION

This object is solved by a reusable goods carrier that is designed and adapted for being used in a goods carrier circulation system. An access point for a beacon is attached to the goods carrier. The basic idea of the invention is to not install the access points in fixed locations, for example in supermarkets or at transport service providers, but to allow the access points to circulate with the reusable goods carriers. The mobile access point can then be used to forward information about the reusable goods carrier carrying the access point and/or about other reusable goods carriers in the vicinity.

The access point can be one that works according to the BLE standard (Bluetooth Low Energy). The access point on the reusable goods carrier thus establishes the communication interface to the service provider and can transmit data, in particular the identifier received from a beacon, as well as its own location, since the access point is equipped with GPS and a telecommunications network connection. In addition, the use of a BLE standard can help keep costs down, since such transponders are widely available and therefore inexpensive to purchase.

According to one embodiment, the reusable goods carrier includes an energy source that supplies the access point with electrical energy. In addition, an energy generation unit is provided on the reusable goods carrier, which is designed to charge the energy source with electrical energy. This ensures that the access point is always operational, even without a large and therefore expensive battery, because the energy source is automatically charged by the energy generation unit.

The energy source can be a rechargeable battery, for example. This means that a certain amount of electrical energy can be stored and accessed at any time, so that the access point is still operational even when no energy can be obtained with the energy generation unit.

Alternatively, it is conceivable to provide only one energy source, whereby a compromise must be made here between the maximum operating time of the access point and the costs for a correspondingly large battery.

According to one embodiment, a beacon is additionally attached to the reusable goods carrier. This enables the reusable goods carrier to transmit its identifier directly via the access point.

Alternatively, the identifier for the reusable goods carrier equipped with the access point can also be stored in the access point itself, so that no beacon has to be provided separately.

The beacon of the reusable goods carrier can also work according to the BLE standard. This ensures that the access point can communicate with the beacon.

In principle, other communication standards can be used as an alternative to the BLE standard. It is important that the beacon and the access point use the same communication standard to ensure data transmission between the beacon and the access point. It is also important that the communication standard is one that uses the energy required to supply the components sparingly.

According to one embodiment, the reusable goods carrier that is equipped with the beacon is also provided with an energy source that supplies the beacon with electrical energy. The energy source for the beacon can be, for example, a capacitor or a battery.

In addition, a further energy generation unit can be provided on the reusable goods carrier, which is intended and designed to charge the energy source of the beacon with electrical energy. Just as with the energy source and the energy generation unit of the access point, it can thus be ensured that the beacon is operational at all times. In particular, if a capacitor is provided as the energy source, which is discharged to supply the beacon with electrical energy, an energy generation unit is provided to ensure longer operating times.

According to one embodiment, the energy generation unit is designed to convert kinetic energy, heat, light or electromagnetic energy into electrical energy. An example of such an energy generation unit, which is based on the conversion of light, is a solar cell attached to the reusable goods carrier. Accordingly, the energy source is recharged whenever light falls on the solar cell of the reusable goods carrier, i.e. optimally sunlight or even artificial light in closed rooms.

Instead of a solar cell, it is also conceivable to provide a shock-sensitive coating on the underside of the reusable goods carrier, which gives way slightly when the reusable goods carrier is set down. This movement caused by the pressure can be converted into electrical energy by a corresponding generator.

Energy generation based on the Seebeck effect is also conceivable, in which a thermoelectric material is provided on the reusable goods carrier. If there is a temperature difference within the thermoelectric material, a voltage is generated that can be used to charge the energy source.

Alternatively, the energy generation unit can also convert radio waves from the environment into electrical energy, which is also referred to as energy harvesting. For this purpose, a piezoelectric material is provided on the reusable goods carrier, which generates an electric current under the influence of the radio waves.

The object is also solved by a goods carrier circulation system with a plurality of reusable goods carriers as described above. In addition, the goods carrier circulation system comprises a multiplicity of reusable goods carriers which are provided only with a beacon. The ratio of reusable goods carriers with an access point to reusable goods carriers with only a beacon is less than 1:20. In particular, the ratio is less than 1:50 and is particularly preferred in the range of 1:100. The reusable goods carriers with the access point circulate randomly within the goods carrier circulation system. By using only a fraction of the reusable goods carriers with access points compared to the total number of reusable goods carriers circulating in the goods carrier circulation system, costs can be kept low because beacons are significantly cheaper than access points. Nevertheless, there are so many access points in circulation that there is a sufficiently high probability that at least one access point is present at every relevant point along the circulation chain, via which the reusable goods carriers which do not contain an access point themselves, can indirectly send their identifier to an assigned server by connecting to the access point.

It may be envisaged that additional disposable goods carriers are in circulation that are provided with a beacon. This beacon then connects to the access point of a reusable goods carrier and can also send its identifier to the logistics server.

In addition, the object is solved by a method for transmitting location information from reusable goods carriers, which are provided only with a beacon within the goods carrier circulation system, as just described, to a logistics server. In a first step, a beacon sends its identifier to an access point that is directly or indirectly within its range. In a second step, the access point transmits the beacon's ID and its own location information to the logistics server via a telecommunications network. The location of the access point is considered to be the approximate location of the beacon.

This process can be used to transmit location information in real time from both reusable goods carriers with access points and from reusable goods carriers that are only equipped with a beacon, via the access point of a reusable goods carrier to a logistics server, without the need to install fixed access points at the premises of participants in the goods carrier circulation system, such as logistics centers, points of sale or producers.

It is also possible for several beacons to communicate with each other, so that a beacon within whose range there is no access point can transmit its identifier to an access point via at least one other beacon. Thus, the communication between the beacons forms a local logistics data network of the reusable goods carriers, so that even those reusable goods carriers that are further away from the nearest access point than their beacon can transmit can indirectly send their identifier to the access point via the other beacons and the mesh network established between them, which in turn forwards it to the logistics server together with its own location information.

Finally, the object is also solved by a mobile logistics data network, which is set up by means of the reusable goods carriers that circulate within the goods carrier circulation system described above between at least the loading station, logistics centers, means of transport and points of sale. The beacons are interconnected with each other to form a network and connected to at least one logistics server via the access points, so that beacons within range of which there is no access point can send their identifier to an access point, which in turn sends the identifier to the logistics server via a telecommunications network. Accordingly, without fixed access points, it can be ensured that the beacons send their identifier to the logistics server, since the beacons form a mobile logistics data network (mesh network) among themselves.

### BRIEF DESCRIPTION OF THE DRAWINGS

Further features and advantages of the invention will become apparent from the following description and the drawings, to which reference is made. In the drawings,

FIG. 1 shows a schematic representation of a goods carrier circulation system according to the invention;

FIG. 2 shows a schematic representation of a reusable goods carrier with a beacon;

FIG. 3 shows a perspective view of a first embodiment of a reusable goods carrier with an access point according to the invention;

FIG. 4 shows a perspective view of a second embodiment of the reusable goods carrier with an access point according to the invention; and

FIG. 5 shows a schematic representation of a mobile logistics data network according to the invention.

### DETAILED EXPLANATION OF THE INVENTION

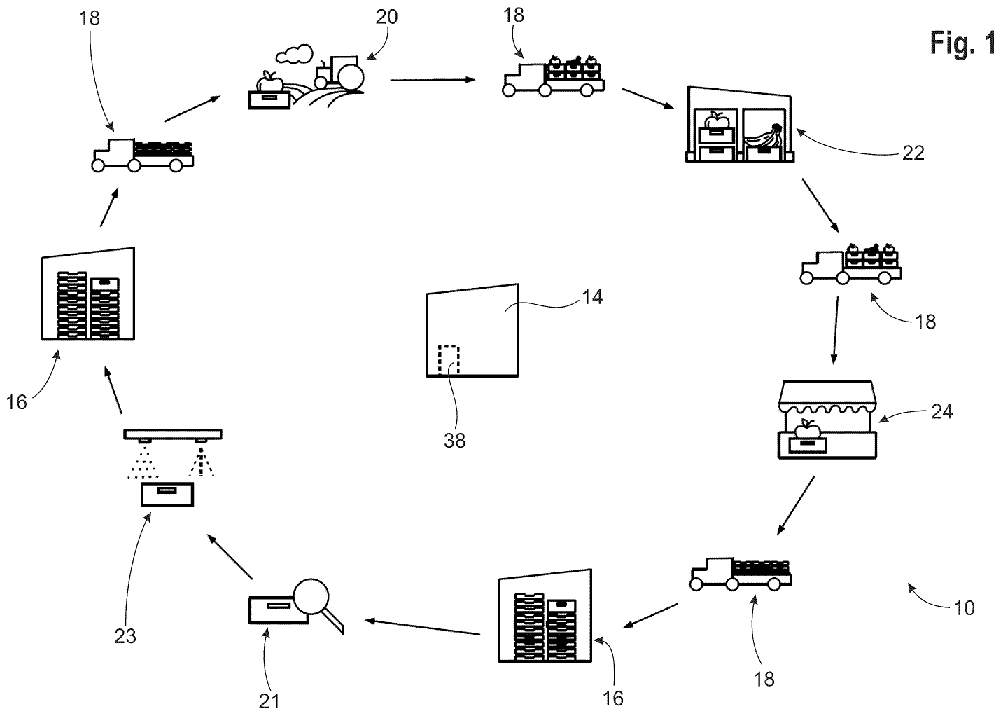

FIG. 1 shows a goods carrier circulation system 10 according to the invention, in which a plurality of reusable goods carriers 12 circulate between different stations. For the sake of readability, only the term “goods carrier” will be used below when referring to the reusable goods carrier 12.

Usually, the goods carriers 12 are provided by a service provider 14, who maintains and cleans the goods carriers 12 and allocates them to the various producers.

The goods carriers 12 can be crate-like containers as shown in the figures, but also pallets, trays, crates or box-shaped containers. In particular, when the goods carriers 12 are box-or container-shaped containers, they can be designed to be foldable or collapsible so that they require as little storage space as possible, as can be seen in FIG. 1.

The goods carrier circulation system 10 shown in FIG. 1 is merely an example, so that any goods carrier circulation system 10 can also have more or fewer than the eleven stations shown in FIG. 1.

In the embodiment shown here, goods carriers 12 are delivered by the service provider 14 from a logistics center 16 by means of a means of transport 18, here a truck, to loading stations 20. After the goods carriers 12 have been filled by producers at the filling station 20, they are delivered to a central distribution center 22, from which the goods carriers 12 and their contents are transported (possibly via intermediaries) to the corresponding points of sale 24. When the goods carriers 12 are no longer needed by the points of sale 24, they are transported to another logistics center 16 of the service provider 14, where they are inspected and cleaned at a receiving station 21 and a cleaning station 23 before they can be delivered to a loading station 20 again.

Depending on the size of the goods carrier circulation system 10, in particular based on the number of participants and the countries to be supplied, several hundred thousand goods carriers 12 can circulate in a goods carrier circulation system 10. Usually, several tens of thousands of goods carriers 12 are stored in the logistics centers 16 and 4,000 to 6,000 goods carriers 12 are transported by the means of transport 18. Accordingly, it is important for the service provider 14 to know the locations of the goods carriers 12 in order to ensure that the goods carriers 12 circulate as efficiently as possible.

Generally speaking, the location information is sent to a logistics server via mobile access points. In this case, an identifier of a beacon is “married” to the location information of the access point that forwards the identifier to the logistics server.

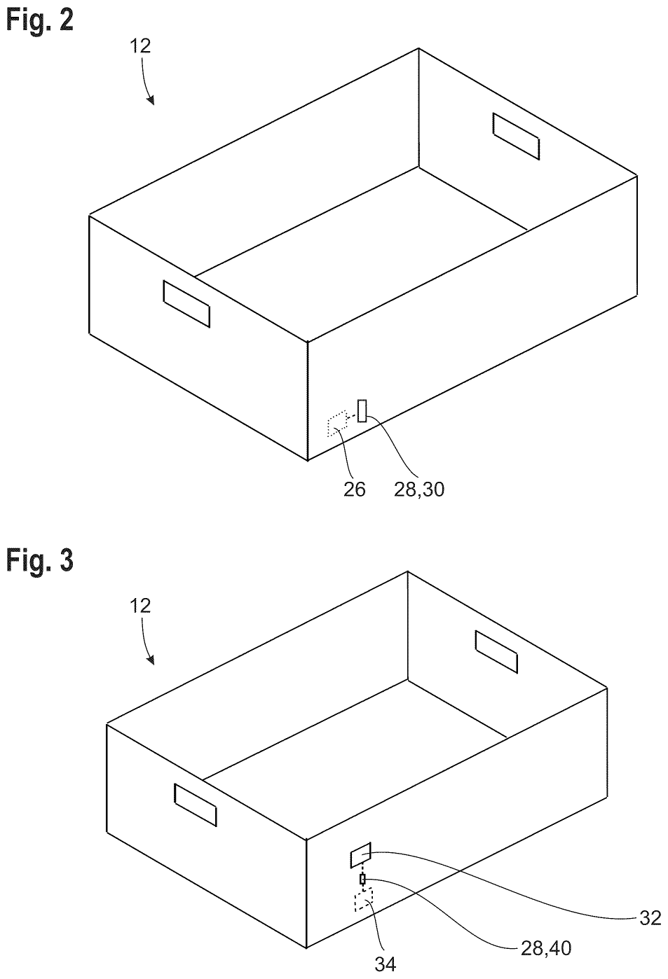

In this system, two different types of goods carriers 12 are used, which are shown in FIGS. 2 and 3.

A beacon 26, i.e. a small radio transmitter, is attached to the goods carrier 12 shown in FIG. 2. An individual identifier is stored in the beacon 26, which the beacon 26 can transmit. On the part of the logistics service provider, which circulates the goods carriers 12 in a circulation operation, the identifier of the beacon is assigned an identification number of the individual goods carrier 12.

An energy source 28 is provided to continuously supply the beacon 26 with electrical energy. In the example shown here, the energy source 28 is a battery 30.

Alternatively, a capacitor can be provided as the energy source.

In order to extend the period of time during which the beacon 26 can transmit, an energy generation unit 32 is also provided. The energy generation unit 32 is designed and constructed to charge the energy source 28, i.e. the battery 30 or the capacitor, with electrical energy. The functioning of the energy generation unit is explained in more detail below with reference to FIG. 3.

FIG. 3 shows an embodiment of a goods carrier 12 according to the invention, wherein an access point 34 for a beacon 26 is attached to the goods carrier 12.

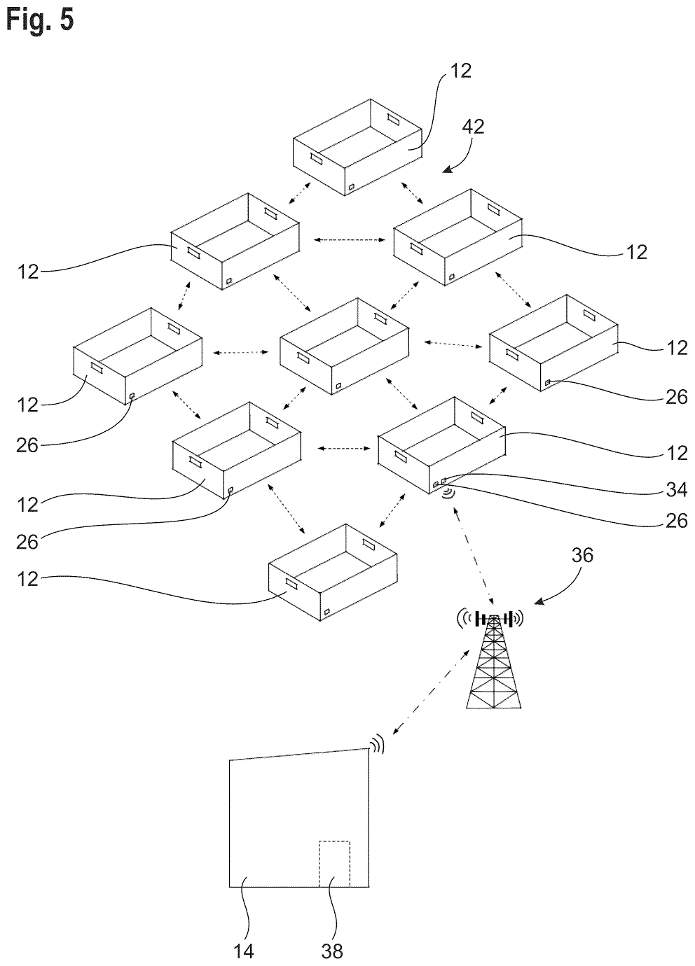

The access point 34 is adapted for determining its location using GPS and to provide an interface to a telecommunications network 36 (see FIG. 5). In addition, the access point 34 can collect information from one or more beacons 26 (i.e. their ID) and forward this information to a logistics server 38 of the service provider 14 via a telecommunications network 36.

Just as for the goods carrier 12 with the beacon 26 described in relation to FIG. 2, an energy source 28 and an energy generation unit 32 are provided for the goods carrier 12 of FIG. 3 with the access point 34. The energy source 28 is preferably a rechargeable battery 40, i.e. a rechargeable accumulator.

In addition, an energy-generating unit 32 is attached to the goods carrier 12, which is adapted for converting kinetic energy, heat, light or electromagnetic energy into electrical energy in order to charge the energy source 28, i.e. the rechargeable battery 40, with electrical energy.

In the example shown in FIG. 3, the energy-generating unit 32 is a solar cell that accordingly converts light into electrical energy.

Instead of a solar cell, a shock-sensitive material can also be provided on an underside of the goods carrier 12. In this case, the pressure when the goods carrier 12 is set down deforms the shock-sensitive material, whereby the pressure released by the movement can be converted into electrical energy by a corresponding generator.

Alternatively, a piezoelectric material can also be provided on the goods carrier 12. Radio waves in the environment generate a current in the piezoelectric material, which can be used to charge the energy source 28, so that the energy-generating unit effectively converts electromagnetic energy into electrical energy.

It is also possible to convert heat into electrical energy by attaching a thermoelectric material to the goods carrier 12. This is done by exploiting the Seebeck effect, according to which a voltage is generated in the thermoelectric material when there is a temperature difference within the material.

To supply the Beacon 26 with electrical energy, a (slightly larger) battery can be used as an alternative to the combination of energy generation unit and storage. The Beacon 26 has such a low energy consumption that the battery can last for up to 10 years, especially up to 15 years.

For the merchandise supports that are provided with the access point 34, a design with only a battery usually makes no sense, since the energy requirement for the access point 34 is too great for a satisfactory operating time to be achieved with only a battery.

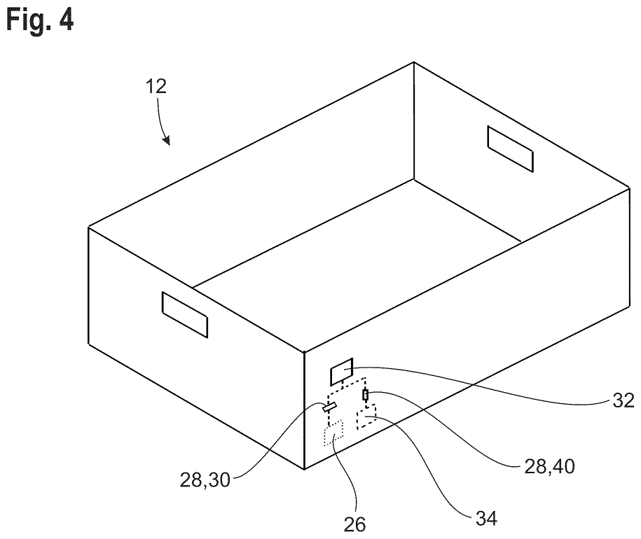

An alternative embodiment of the goods carrier 12 according to the invention is shown in FIG. 4, which, like the goods carrier 12 shown in FIG. 3, has an access point 34, an energy generation unit 32 and an energy source 28. In addition to the access point 34, a beacon 26 is attached to the goods carrier 12 shown in FIG. 4, which essentially corresponds to the beacon 26 described in relation to FIG. 2.

In order to keep the number of electrical components as small as possible and thus to reduce costs, in the embodiment of the goods carrier 12 shown in FIG. 4, only one energy generation unit 32 is provided, which charges both the energy source 28 for the access point 34 and the energy source 28 for the beacon 26 with electrical energy.

Alternatively, it is of course possible to provide a separate energy generation unit 32 for both the access point 34 and the beacon 26, or not to provide any energy generation unit 32 for the beacon 26.

Preferably, both the access points 34 and the beacons 26 of the goods carriers 12 circulating in the goods carrier circulation system 10 use the BLE standard (Bluetooth Low Energy). Such beacons 26 are characterized by low costs. In addition, beacons 26 that work according to the BLE standard require only very little electrical energy to transmit data, i.e. their identifier.

As an alternative to the BLE standard, the access points 34 and the beacons 26 can, of course, also work according to other standards. The only important thing here is that the access points 34 and the beacons 26 work according to the same standard within a goods carrier circulation system 10, so that communication between the beacons 26 and the access points 34 is possible.

Since the access points 34 are considerably more expensive than the beacons 26, there are far fewer goods carriers 12 with access point 34 in circulation within the goods carrier circulation system 10 than goods carriers 12 with beacon 26. The distribution is purely random. The ratio of goods carriers 12 with access point 34 to goods carriers 12 with only one beacon 26 is smaller than 1:20, in particular smaller than 1:50 and preferably in the range of 1:100. Due to the high number of goods carriers 12 that are normally located at each point along the circulation circuit, ensures with a high degree of probability that even with such a small proportion of 1% of goods carriers 12 with access points 34, there is always at least one access point 34 available with which the remaining beacons 26, which are located at each point along the circulation circuit, can send their identifier via the access point 34 to the logistics server.

While the beacons 26 cannot transmit their identifier to the logistics server 38 themselves, the beacons 26 can, however, communicate with each other, so that a mobile logistics data network 42 is established by the beacons 26 that are close to each other, as shown in FIG. 5.

The logistics data network 42 can thus also be used to transmit the identifier of a goods carrier 12 to the logistics server 38, which does not have its own access point 34 and within whose immediate range there is no access point 34.

Accordingly, the beacon 26 of a goods carrier 12 without an access point 34 transmits its identifier to an access point 34 within its range in a first step in order to transmit location information. In a second step, the access point 34 then transmits the identifier received from the beacon 26 and its own location information to the logistics server 38 via the telecommunications network 36.

In this case, the location of the access point 34 is regarded as the approximate location of the beacon 26, so that at least the current station within the goods carrier circulation system 10 for the goods carrier 26 can be correctly assigned with only the beacon 26.

Beacons 26 that do not have an access point 34 within their direct range can send their identifier to a beacon 26 within their range, which then forwards the identifier to the next access point 34 within its range, or, if this is not the case, forwards the identifier to a further beacon 26. In this way, the identifier can be sent indirectly to the access point 34 via the mesh network established between the beacons 26.

Since the goods carriers 12 with access point 34 happen to circulate within the goods carrier circulation system 10, constant transmission of location information is possible without the goods carriers 12, in particular their beacon 26, having to pass a fixed access point 34 to transmit data, in particular their identifier.

In addition to the location information, the identifier transmitted via the access point 34 can be assigned to a specific goods carrier 12 within a database on the logistics server 38, so that, in addition to the location information of the goods carrier 12, information about its current use can also be obtained. This information includes, for example, suppliers, shops and/or products to which the goods carrier 12 is currently assigned.

Single-use goods carriers, such as cardboard boxes, can also be integrated into the circulation system, for example, and also be equipped with a beacon. This is useful if the information about the location of the single-use goods carrier is so relevant that it justifies the expense of the beacon, which is then only used once.

1. A second reusable goods carrier for a goods carrier circulation system, comprising:
a second reusable goods carrier body configured for containing goods;
an access point attached to the second reusable goods carrier body, the access point comprising:
a transponder for wirelessly receiving a first individual identifier from a first beacon of a first reusable goods carrier and to wirelessly transmit data containing the first individual identifier;
a GPS configured to determine the location of the second reusable goods carrier body; and
a telecommunications network connect; and
a second energy source attached to the second goods carrier body, the second energy source being configured to supply the second access point with electrical energy,
wherein, when the first beacon transmits the first individual identifier to the access point, the access point wirelessly transmits the first individual identifier received from the first beacon and the location of the second reusable goods carrier body to a logistics server via the telecommunications network connect, thereby allowing a location of the first reusable goods carrier body to be approximated based on the location of the second reusable goods carrier body.

2. The second reusable goods carrier according to claim 1, wherein the access point works according to the BLE standard (Bluetooth Low Energy).

3. The reusable goods carrier according to claim 1, wherein a second energy-generating unit is provided on the second reusable goods carrier body, which is provided and designed to charge the second energy source with electrical energy.

4. The second reusable goods carrier according to claim 1, wherein the second energy source is a rechargeable battery.

5. The second reusable goods carrier according to claim 1, wherein a first energy-generating unit is provided on the first reusable goods carrier, which is provided and designed to charge a first energy source on the first reusable goods carrier with electrical energy.

6. The second reusable goods carrier according to claim 1, wherein the first beacon works according to the BLE standard (Bluetooth Low Energy).

7. The second reusable goods carrier according to claim 1, further comprising a second beacon attached to the second reusable goods carrier body, wherein a second individual identifier corresponding to a second identification number of the second reusable goods carrier body is stored in the second beacon.

8. The second reusable goods carrier according to claim 1, wherein the access point includes a storage medium for storing a second individual identifier corresponding to a second identification number of the second reusable goods carrier body.

9. The second reusable goods carrier according to claim 3, wherein the second energy-generating unit is adapted for converting kinetic energy, heat, light or electromagnetic energy into electrical energy.

10. A goods carrier circulation system comprising:
a first plurality of first reusable goods carriers, each of the first plurality of first reusable goods carriers comprising:
a first reusable goods carrier body configured for containing goods;
the first beacon attached to the first reusable goods carrier body; and
a first energy source attached to the first goods carrier body, the first energy source being configured to supply the first beacon with electrical energy; and
a second plurality of second reusable goods carriers according to claim 1;
wherein a ratio of the second plurality of second reusable goods carriers to the first plurality of first reusable goods carriers is less than 1:20, and
wherein the second plurality of second reusable goods carriers point circulate randomly within the goods carrier circulation system.

11. The goods carrier circulation system according to claim 10, characterized in that disposable goods carriers, which are provided with a beacon, additionally circulate.

12. A method for transmitting location information from reusable goods carriers within a goods carrier circulation system to a logistics server,
wherein the goods carrier circulation system comprises:
a first plurality of reusable goods carriers, each of the first plurality of reusable goods carriers comprising:
a first reusable goods carrier body configured for containing goods;
a first beacon attached to the first reusable goods carrier body, wherein a first individual identifier corresponding to a first identification number of the first reusable goods carrier body is stored in the first beacon; and
a first energy source attached to the first goods carrier body, the first energy source being configured to supply the first beacon with electrical energy; and
a second plurality of reusable goods carriers, each of the second plurality of reusable goods carriers comprising:
a second reusable goods carrier body configured for containing goods;
an access point attached to the reusable goods carrier body, the access point comprising:
a transponder for wirelessly receiving the first individual identifier from the first beacon and to wirelessly transmit data containing the first individual identifier;
a GPS configured to determine the location of the second reusable goods carrier body; and
a telecommunications network connect; and
a second energy source attached to the second goods carrier body, the second energy source being configured to supply the second access point with electrical energy;
wherein a ratio of the first plurality of reusable goods carriers to the second plurality of reusable goods carriers is less than 1:20,
wherein, in a first step, the first beacon transmits the first individual identifier to the access point, and
wherein, in a second step, the access point wirelessly transmits the first individual identifier of the first beacon and the location of the second reusable goods carrier body via the telecommunications network to the logistics server, the location of the access point being regarded as the approximate location of the first beacon.

13. The method according to claim 12, characterized in that a plurality of beacons in the second plurality of reusable goods carriers communicate with each other so that a beacon within whose range there is no access point can also transmit its identifier to an access point via at least one other beacon.

14. A mobile logistics data network set up by means of reusable goods carriers,
wherein the reusable goods carriers randomly circulate within a goods carrier circulation system between at least a plurality of stocking stations, a plurality of logistics centers, a means of transport, and a point of sale,
wherein the reusable goods carriers include a first plurality of reusable goods and a second plurality of reusable goods carriers,
wherein each of the first plurality of reusable goods carriers comprises:
a first reusable goods carrier body configured for containing goods;
a first beacon attached to the first reusable goods carrier body, wherein a first individual identifier corresponding to a first identification number of the first reusable goods carrier body is stored in the first beacon; and
a first energy source attached to the first goods carrier body, the first energy source being configured to supply the first beacon with electrical energy;
wherein each of the second plurality of reusable goods carriers comprises:
a second reusable goods carrier body configured for containing goods;
an access point attached to the second reusable goods carrier body, the access point comprising:
a transponder for wirelessly receiving the first individual identifier from the first beacon and to wirelessly transmit data containing the first individual identifier;
a GPS configured to determine the location of the second reusable goods carrier body; and
a telecommunications network connect; and
a second energy source attached to the second goods carrier body, the second energy source being configured to supply the second access point with electrical energy;
wherein a ratio of the second plurality of reusable goods carriers to the first plurality of reusable goods carriers is less than 1:20, and
wherein, when the access point wirelessly receives the first individual identifier from the first beacon, the access point wirelessly transmits the first individual identifier received from the first beacon and the location of the second reusable goods carrier body to a logistics server via the telecommunications network connect, thereby allowing a location of the first reusable goods carrier body to be approximated based on the location of the second reusable goods carrier body.

15. The goods carrier circulation system of claim 10, wherein the ratio of the second plurality of reusable goods carriers to the first plurality of reusable goods carriers is less than 1:50.

16. The goods carrier circulation system of claim 10, wherein the ratio of the second plurality of reusable goods carriers to the first plurality of reusable goods carriers is less than 1:100.

17. The goods carrier circulation system of claim 10, wherein each of the second reusable goods carriers each comprises:
a second beacon attached to the second reusable goods carrier body, wherein a second individual identifier corresponding to a second identification number of the second reusable goods carrier body is stored in the second beacon.

18. The mobile logistics data network of claim 14, wherein each of the second reusable goods carriers each comprises:
a second beacon attached to the second reusable goods carrier body, wherein a second individual identifier corresponding to a second identification number of the second reusable goods carrier body is stored in the second beacon.
